(19) United States
(12) Patent Application Publication
(10) Pub. No.: US 2026/0179304 A1
(43) Pub. Date: Jun. 25, 2026

(54) TECHNIQUES FOR IMPROVING COMPRESSION BY FORCING A HIT FOR BOUNDING VOLUMES OF A BVH

(71) Applicants: Advanced Micro Devices, Inc., Santa Clara, CA (US); ATI Technologies ULC, Markham (CA)

(72) Inventors: Daniel James Skinner, Cambridge (GB); David William John Pankratz, Edmonton (CA); David Kirk McAllister, Santa Clara, CA (US)

(73) Assignees: Advanced Micro Devices, Inc., Santa Clara, CA (US); ATI Technologies ULC, Markham (CA)

(21) Appl. No.: 18/990,229

(22) Filed: Dec. 20, 2024

(51) Int. Cl. G06T 15/06; G06T 15/00

(52) U.S. Cl. CPC G06T 15/06; G06T 15/005; G06T 2210/12; G06T 2210/21

(57) ABSTRACT

Data for nodes of a bounding volume hierarchy can be represented in fixed-point format for compression. For good precision, fixed-point bounds are stored along with each node, where these bounds represent the minimum and maximum representable numbers in the format. While this provides good compression, there are ways in which this technique can produce undesirable results. For example, if the size of many or most of the bounding volumes in the fixed-point number space is significantly smaller than the bounds, then the representation of such bounding volume in the fixed-point space may be unnecessarily large, resulting in a large number of false positive intersections during BVH traversal. Thus, techniques are provided herein for setting certain bounding volumes as “always hit” in order to eliminate the bounding volumes from inclusion in the fixed-point bounds. This shrinks the fixed-point bounds, giving better precision for smaller bounding volumes.

### BACKGROUND

In image synthesis, ray tracing is utilized to find a nearest intersection of a given ray with a scene where light propagation is simulated.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates a BVH builder, according to an example;

FIG. 6A illustrates an example BVH generated by a BVH builder, according to an example;

FIG. 6B illustrates another example BVH;

FIG. 7 illustrates representation of data for a node in a fixed-point format;

FIG. 8 illustrates an example in which a node reference is marked as “always hit;”

FIG. 9 is a flow diagram of a method for traversing a BVH with one or more node references marked as “always hit,” according to an example; and

FIG. 10 is a flow diagram of a method for setting one or more node references of a node to “always hit,” according to an example.

### DETAILED DESCRIPTION

Ray tracing is a rendering technique whereby rays are cast into a scene and pixels of a render target are colored based on which objects the rays intersect. To speed such operations up, a ray tracing system typically builds an acceleration structure such as a bounding volume hierarchy (“BVH”). Such a structure has a hierarchy of levels, where each level can include nodes. Each node has references to other nodes as well as a bounding volume that encloses the geometry of those other nodes. When traversing the BVH, the ray is tested for intersection with such bounding volumes and traversal to the nodes referenced does not occur if the ray does not intersect the bounding volumes.

Data for nodes of the BVH can be represented in fixed-point format for compression. In fixed point format, the minimum increment represented by adjacent values in the number space is the same regardless of the magnitude of the number being represented. Such a fixed-point format, which eschews use of an exponent provides good compression. Objects such as bounding volumes of a node are represented in the fixed-point format.

For good precision, fixed-point bounds are stored along with each node, where these bounds represent the minimum and maximum representable numbers in the format. While this provides good compression, there are ways in which this technique can produce undesirable results. For example, if the size of many or most of the bounding volumes in the fixed-point number space is significantly smaller than the bounds, then the representation of such bounding volumes in the fixed-point space may be unnecessarily large, resulting in a large number of false positive intersections during BVH traversal. Thus techniques are provided herein for setting certain bounding volumes as “always hit” in order to eliminate the bounding volumes from inclusion in the fixed-point bounds. This shrinks the fixed-point bounds, giving better precision for smaller bounding volumes at the cost of a potentially larger bounding volume for those marked as “always hit.”

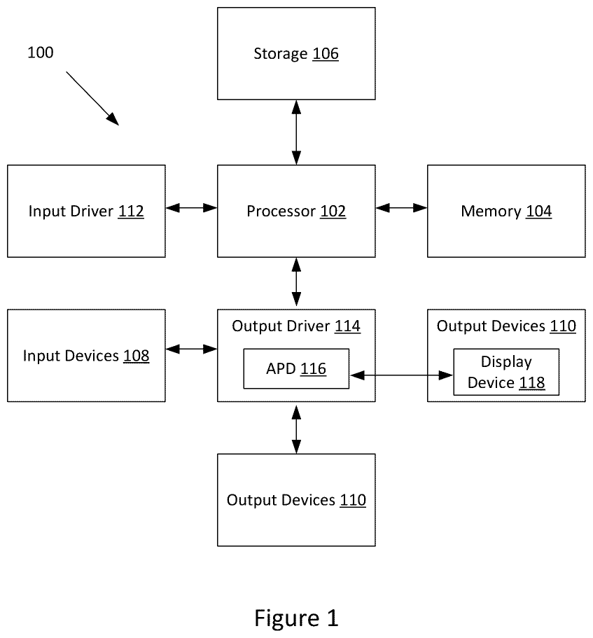

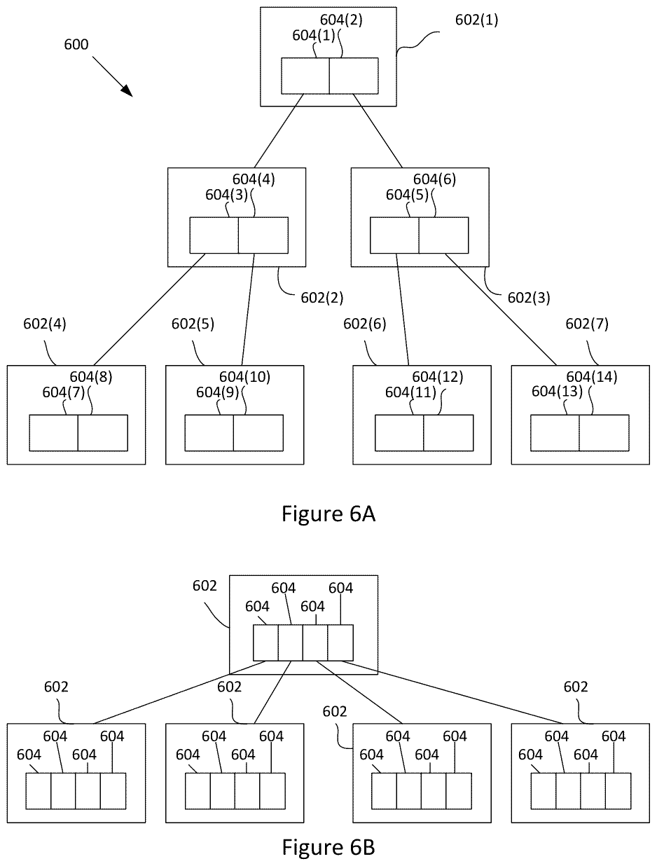

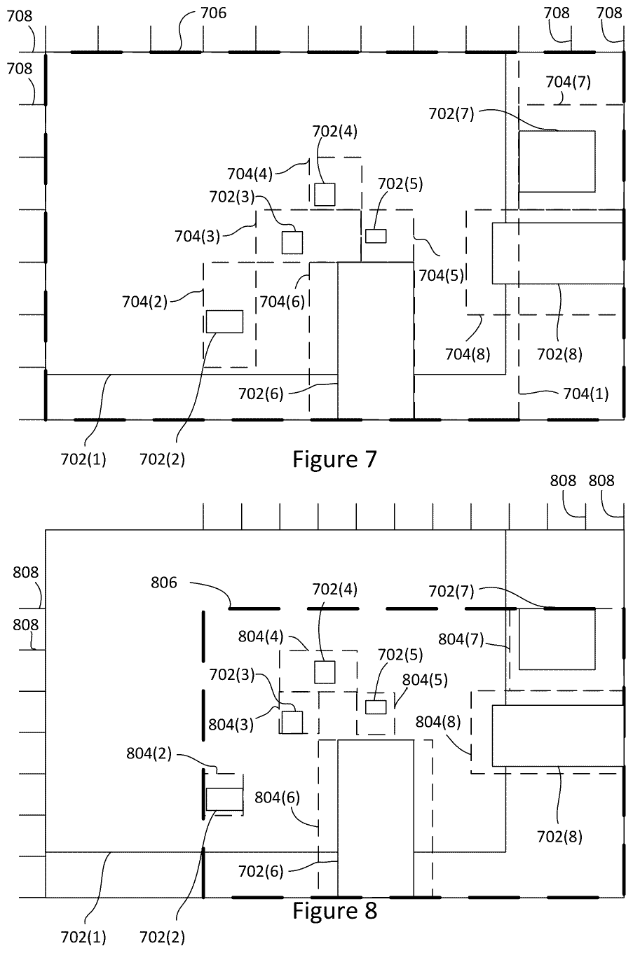

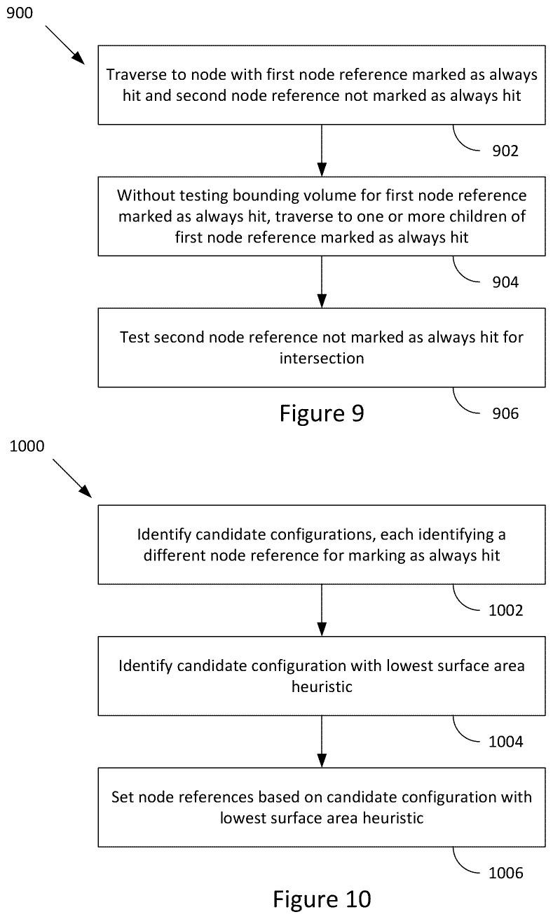

In the present disclosure, FIGS. 1-4 provide background for ray tracing. FIGS. 6A-6B illustrate example BVHs. FIGS. 7 and 8 illustrate the consequences of marking a bounding volume as “always hit.” FIG. 9 illustrates a technique for traversing a BVH and FIG. 10 illustrates a technique for determining which bounding volumes to mark as “always hit.”

FIG. 1 is a block diagram of an example device 100 in which one or more features of the disclosure can be implemented. The device 100 can include, for example, a computer, a gaming device, a handheld device, a set-top box, a television, a mobile phone, server, a tablet computer or other types of computing devices. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a parallel processing paradigm, such as a single-instruction-multiple-data (“SIMD”) paradigm or a single-instruction-multiple-threads (“SIMT”). Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a parallel processing paradigm may perform the functionality described herein. Alternatively, it is contemplated that computing systems that do not perform processing tasks in accordance with a parallel processing paradigm can also perform the functionality described herein. The APD 116 includes APD memory 139, which is available for the compute units 132, and local data share memory 137, which is local to each compute unit 132 and is available to its respective compute unit 132.

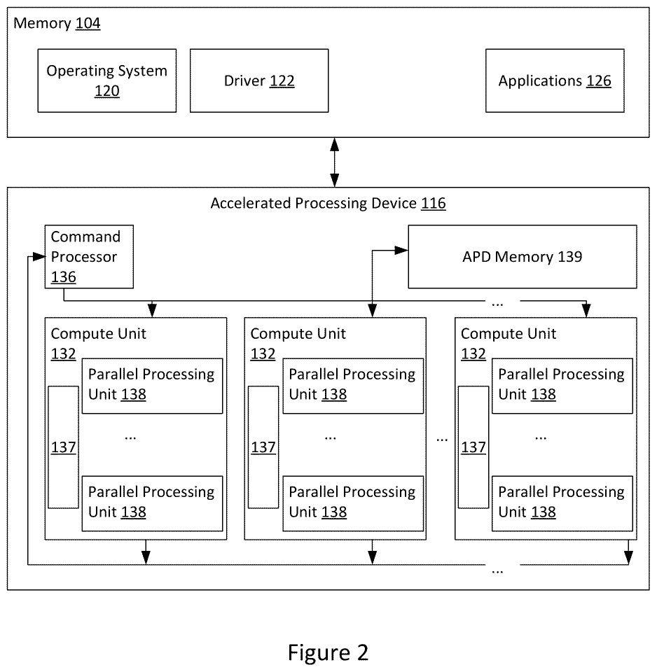

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen lanes, where each lane executes the same instruction at the same time as the other lanes in the parallel processing unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps. One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A scheduler 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

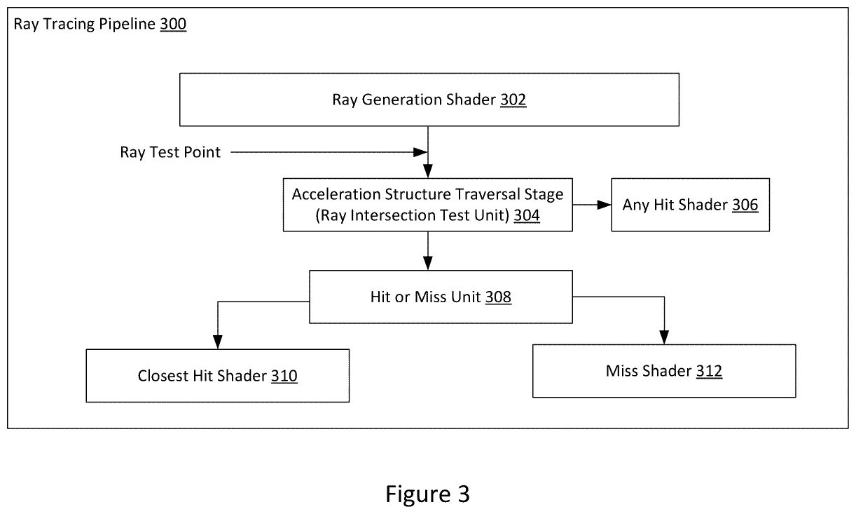

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

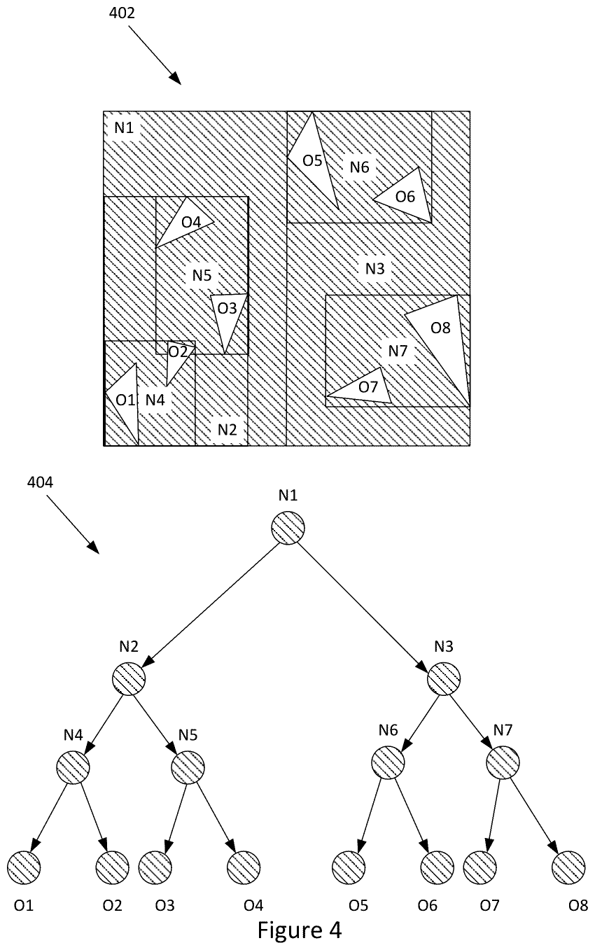

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the test for that non-leaf node fails. In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

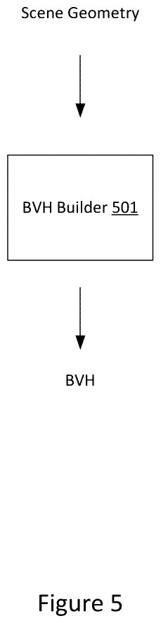

FIG. 5 illustrates a BVH builder 501, according to an example. The BVH builder 501 accepts scene geometry and generates a BVH. The scene geometry includes information such as primitive vertex coordinates and attributes, mesh information, and other information specifying the geometry for a scene. The output BVH is a BVH for that scene geometry. More specifically, the leaf nodes of the BVH include indications of (e.g., pointers to) one or more primitives of the scene geometry and the non-leaf nodes include bounding volumes and references (e.g., pointers) to other nodes as described above. Any technically feasible technique for generating a BVH from scene geometry may be used. In various examples, the BVH builder 501 is software executing on a processor (e.g., processor 102, APD 116, or both), circuitry (e.g., digital circuitry), or a combination thereof.

FIG. 6A illustrates an example BVH 600 generated by a BVH builder 501, according to an example. It should be understood that only a portion of the BVH 600 is illustrated, and that this illustrated portion includes non-leaf nodes 602 as an example.

Each illustrated non-leaf node 602 includes a plurality of node references 604. Each node reference 604 includes a bounding volume and a pointer to another node 604. The bounding volume bounds all geometry of the node 604 pointed to by the pointer. In the case that the node 604 pointed to is a non-leaf node, the bounding volume bounds all bounding volumes of the node references of that node. For instance, node reference 604(1) includes a bounding volume and a pointer that points to node 602(2). The bounding volume of node reference 604(1) bounds both the bounding volume of node reference 604(3) and the bounding volume of node reference 604(4). Put more generally, the bounding volume of a node reference 604 bounds all descendant geometry of the node pointed to by that node reference 604.

Although it is shown that there are two children for each node 602 in FIG. 6A, this number is just illustrative, and a node 602 can have more children than that. FIG. 6B illustrates an example where nodes are permitted to have more than two child nodes and, in this example, each node 602 includes four node references 604, each of which points to a different node 602.

It is sometimes desirable to compress the contents of one or more nodes 602. One technique for performing such compression includes representing the contents of a node 602 in a fixed point rather than floating point format. With floating point, numbers are represented with a mantissa and an exponent. The value of the floating point number is equal to the mantissa multiplied by 2 to the power of the exponent. One aspect of floating point numbers is that they can represent a very wide range of numbers with a wide range of precision. Another aspect of floating point numbers is that the closest representable increment in floating point numbers (e.g., the magnitude of the amount that differs between two adjacent representable values) is different depending on the magnitude of the value being represented. For example, values close to 0 have very small increments, while larger values (e.g., 1,000, 1,000,000) have much larger increments.

In certain situations, such as where the number of possible representable values is restricted in range, floating point representation is both unnecessary and inefficient. In relation to BVHs, the range of possible values in a node 602 is known. For example, there are a limited number of bounding volumes within a given node 602. Each bounding volume is represented with lowest and highest values in each axis (e.g., x, y, z). Thus for each axis, the minimum and maximum value needed for each axis is known. In a simple example, if a node 602 has a node reference 604 with a first bounding volume having low coordinates x: −1, y: 2, z: 105.5 and high coordinates x: 2, y: 50, z: 2000, and a second bounding volume having low coordinates x: −50.3, y: 100, z: 20 and high coordinates x: 22, y: 603.22, z: 10000, then it is known that the minimum x value is −50.3, the maximum x value is 22, the minimum y value is 2, the maximum y value is 603.22, the minimum z value is 20, and the maximum z value is 10000. It should be understood that in this example, the bounding volumes are axis-aligned bounding volumes, where the minimum and maximum values define the six planes whose intersection for the bounding volume. For example, a minimum x: 1, y: 1, z: 1 and maximum x: 100, y: 150, z: 150 axis-aligned bounding volume defines a box having one face at x=1, another face at x=100, one face at y=1, another face at y=150, one face at z=1, and another face at z=150, with the bounding volume being thus defined by the interior volume within these faces.

As can be seen, it is possible to know the minimum and maximum values for a particular set of data, such as coordinate values of a node 602. The BVH builder 501 thus compresses nodes 602 by representing such values in a fixed-point format, in which each possible value is defined within a known range. In the fixed-point format, the minimum representable increment (e.g., the difference between two adjacent binary values such as 1000 and 1001) is the same regardless of the magnitude of the number. The fixed-point format is thus represented with two endpoints (e.g., per axis) and with a fixed point value that represents an intermediate amount between these two endpoints. In an example, if the two endpoints are 100 and 356, and there are 256 possible values (e.g., 8 bits), then the minimum representable increment is 1. In another example, if the two endpoints are 2000 and 2001 and there are 256 possible values, then the minimum representable increment is 1/256.

FIG. 7 illustrates representation of data for a node 602 in a fixed-point format. In this example, the node 602 has a plurality of node references 604, each of which has a bounding volume. In FIG. 7, each such bounding volume is shown with two representations: a “true” bounding volume 702 and a fixed-point bounding volume 704. Moreover, the bounding volume 706 for the node 602 itself is shown, and this bounding volume 706 bounds all bounding volumes of the node references 604.

As can be seen, the minimum and maximum values for the bounding volumes of the node 602 are shown as the left-most position, the right-most position, the top-most position, and the bottom-most position of the bounding volume 706 for the node. As this area is represented in a fixed-point space, the possible values in this space are represented with tick marks 708. In the horizontal axis, there are 12 tick marks and thus 12 possible values and in the vertical direction, there are 8 tick marks and thus 8 possible values. It should be understood that this is a low number of possible values for a real system, but that this low number is just an example for simplicity of explanation.

The limited number of possible values used to represent the fixed-point bounding volumes 704 means that the fixed-point bounding volumes 704 may be significantly larger than the “true” bounding volumes 702, which are in some global number space (e.g., a floating point space in which the underlying geometry—the primitives represented in the leaf nodes—are defined). This can particularly be the case where at least one of the “true” bounding volumes 702 is much larger than the rest or where there are one or more true bounding volumes 702 that are at a significant distance from the others. Stated differently, a switch to fixed-point, rather than floating-point numbers results in a potential inability to precisely represent small differences in magnitude. This means that, for true bounding volumes 702 that are significantly smaller than the overall bounding volume 706 for the node 602, their boundaries may lie a significant distance from the representable values in the fixed-point space.

The example of FIG. 7 includes eight different true bounding volumes 702 and eight corresponding fixed-point bounding volumes 704. In this example, each of the eight true bounding volumes 702 is the bounding volume 702 of a node reference 604 for the same node 602 (which thus has eight node references 604). The bounding volume for that node 602 is the bounding volume 706.

As can be seen, the fixed-point bounding volumes 704 are larger than the corresponding true bounding volumes 702. For instance, fixed-point bounding volume 704(2) is significantly larger than true bounding volume 702(2). Fixed-point bounding volume 704(5) is significantly larger than true bounding volume 702(5). In general, each fixed-point bounding volume 704 is larger than the corresponding true bounding volume 702 and extends to the nearest tick marks 708.

An issue with using fixed-point numbers in this way is related to the disparity in size between the fixed-point bounding volumes 704 and the true bounding volume 702. Specifically, with a bounding volume that is larger than necessary, hits against that bounding volume will produce more false negatives than necessary. A false negative is a hit on the bounding volume that does not ultimately hit any of the primitives that descend from that bounding volume in the BVH. Any space external to the true bounding volume 702 that is within the fixed-point bounding volume 704 may result in a false positive. In the event that a true bounding volume 702 is particularly small (e.g., compared to the increments of the fixed-point space), this results in a great deal of false positive hits.

It is possible to reduce the size of the fixed-point bounding volumes 704 relative to the true bounding volumes 702 by reducing the size of the bounding volume 706 for the node 602 (i.e., the node 602 that contains the node references 604 corresponding to the true bounding volumes 702). Reducing that size makes the minimum representable increment (e.g., the space between the tick marks 708) smaller, which results in a smaller amount of padding around the true bounding volumes 702. To reduce the size of the bounding volume 706 (which is sometimes referred to herein as an “overall bounding volume 706”), the BVH builder 501 converts one or more of the node references 604 to an “always hit” reference. During traversal of a BVH for rendering, the ray tracing pipeline 300 traverses to a non-leaf node that includes node references 604. For a node reference 604 marked as “always hit,” the ray tracing pipeline 300 does not test the ray for intersection with the bounding volume of that node reference 604 and traverses to the node 602 pointed to by that node reference 604. Converting a node reference 604 to “always hit” allows the bounding volume for that node reference 604 to be removed from the overall bounding volume 706, which reduces the size of the minimum increment in the fixed-point space (e.g., makes the tick marks 708 closer together), since the “always hit” node reference 604 is not included in the overall bounding volume 706. This in turn reduces the size of the fixed-point bounding volumes 704 that surround the true bounding volumes 704, which reduces the false positives for ray tracing operations for corresponding node references 604.

FIG. 8 illustrates an example in which the node reference 604 for the true bounding volume 702(1) is marked as “always hit.” In this example, the overall bounding volume 806 is shrunken as shown. More specifically, the overall bounding volume 806 does not include the bounding volume for the node reference 604 marked as always hit. Instead, the overall bounding volume 806 is defined as the maximum and minimum extents of all node references 604 of the node 602 that are not marked as “always hit.” This allows the minimum increment in the fixed-point space to also shrink, and this in turns allows the fixed-point bounding volumes 704 to be smaller in comparison to the true bounding volumes 702. In the example of FIG. 8, the overall bounding volume 806 encompasses all true bounding volumes 702 except for true bounding volume 702(1), whose corresponding node reference 604 is marked as “always hit.” As a result, the overall bounding volume 806 is smaller than in FIG. 7. This means that the minimum increment—the space between the tick marks 808—is smaller than in FIG. 7. In turn, this means that the size of the fixed-point bounding volumes 804 is smaller than that of the fixed point bounding volumes 704 of FIG. 7. For example, fixed-point bounding volume 804(2) is much smaller than fixed-point bounding volume 704(2), even though both fixed-point bounding volumes bound the same true bounding volume 702(2). Other fixed-point bounding volumes 704 are smaller as well. It should be noted that it is not always the case that a fixed-point bounding volume for a smaller overall bounding volume is smaller than for a larger bounding volume. For example, where the change in tick mark location causes a true bounding volume 702 to span a tick mark where the true bounding volume 702 did not before, the fixed-point bounding volume for the smaller overall volume can increase in size (for example, fixed-point bounding volume 804(6) has a right edge that is further to the right than fixed-point bounding volume 704(6)). However, in general, and especially with significant shrinkage to overall bounding volume 706, fixed-point bounding volumes 704 will shrink.

It should be understood that multiple node references 604, not just one, in any given node 602, can be marked as “always hit,” in which case the overall bounding volume and thus the bounds for the fixed-point number space will bound all node references 604 of a node 602 not marked as “always hit,” and will exclude (or at least does not necessarily include) all node references 604 of a node 602 marked as “always hit.”

It should be understood that although marking one or more node references as “always hit” reduces the fixed-point bounding volumes for other nodes, marking such node references as “always hit” effectively enlarges the fixed-point bounding volume of the node reference marked as “always hit” to be equal to the bounding volume of the parent node. In other words, because the node reference 604 is marked as always hit, the ray will always be considered to intersect the bounding volume of that node, which is the same result as if the bounding volume for that node reference 604 were equal to the bounding volume of the parent node (which is the bounding volume specified by the node reference 604 in the parent node). Thus, there is a cost to pay for marking a node reference 604 as always hit. For this reason, the BVH builder 501 selects when to perform such marking and which node reference 604 to mark, taking into consideration the trade-off between decreased performance for nodes marked as always hit against increased performance for the other nodes.

There are a wide variety of techniques for determining when to mark a node reference 604 as “always hit.” Several examples are now provided.

In one example, if the overall bounding volume 706 is defined solely by the bounding volume for just one of the node references 604, then the BVH builder marks that node reference 604 as “always hit.” In this example, one node reference 604 of a node 602 represents a primitive or set of primitives that is larger than and that surrounds all of the primitives of the other node references 604 of the node 602. In an extension to this example, such a node reference 604 is marked as “always hit” in the event that doing so would reduce the size of the overall bounding volume 706 by a threshold amount. In one example, the threshold amount is a threshold percentage. In another example, the threshold amount is that the exponent of the floating-point value defining that extent is reduced in at least one dimension.

In another example, the BVH builder 501 performs more in-depth consideration to determine which node references 604 to mark as always hit. In general, marking a node reference 604 as always hit, where the bounding volume of the node reference 604 lies on at least one face of the overall bounding volume 706 provides the following benefits and the following costs. The benefit is that the bounding volume 706 shrinks by some amount, which reduces the minimum increment of the fixed-point space, which reduces the size of bounding volumes for other node references 604, thereby reducing the number of false hits that would occur. A cost is that marking such node reference 604 as always hit in at least some instances enlarges the effective bounding volume for that node reference 604, which increases the number of false hits that occur for that node reference 604. As can be seen, there is a trade-off that occurs—if the increased number of false hits results in worse performance than the performance improvement gained by shrinking the fixed-point bounding volumes for the other node references 604, then marking the node reference 604 as always hit is not beneficial. Thus in various examples, the BVH builder 501 determines a performance benefit gained that would occur if a node reference 604 were marked as always hit and marks that node reference 604 as always hit if that performance benefit is greater than the performance detriment that occurs.

Various proxy or heuristic values can be used to represent the performance of a particular configuration, where a “configuration” means an indication of which node references 604 of a node to mark as “always hit” (and thus which node references 604 to not mark as “always hit.” In one example, a measure referred to as the “surface area heuristic” is used as this heuristic value. In this example, the surface area heuristic is calculated as follows. The surface area heuristic for a node 602 is the sum of the surface area of the bounding volume of each node reference 604 of that node. Special consideration is taken for this calculation in order to account for the fixed-point space as well as the node reference(s) 604 marked as “always hit.” In this example, the surface area heuristic for a node 602 having at least one node reference 604 marked as “always hit” is the sum of the fixed-point bounding volumes for each node reference 604 not marked as “always hit” (e.g., with those fixed-point bounding volumes being affected by the marking of the other node reference(s) as “always hit”), added to the bounding volume of the node 602 itself for each node marked as “always hit.” In other words, the BVH builder 501 is calculating a surface area heuristic for a configuration for a node 602, where the configuration includes one or more node references 604 marked as “always hit.” For this configuration, there is an overall volume 706 that bounds the bounding volumes of the node references 604 not marked as “always hit,” and does not necessarily bound any of the bounding volumes of the node references 604 marked as “always hit.” Each node reference 604 not marked as always hit has a corresponding fixed-point bounding volume that bounds the true bounding volume at the precision of the fixed-point number space defined by the overall volume 706 (as well as the number of bits in the fixed-point space—e.g., 8 bits gives 256 possible values). The surface area heuristic is the sum of all such fixed-point bounding volumes, added to the bounding volume of the node 602 itself multiplied by the number of node references 604 marked as “always hit” in the configuration. The BVH builder 501 tests a number of these different configurations and selects the configuration with the lowest surface area heuristic. It should be understood that the sum for the surface area heuristic calculation is calculated in the “global” number space (e.g., floating point). More specifically, for node references 604 not marked as “always hit,” the fixed-point bounding volume for that node reference 604 is calculated, and then that value is converted into the floating point space, which can be summed together and with the bounding volume of the node 602 itself. It should also be understood that the bounding volume for the node 602 is the bounding volume of the node reference 604 that points to that node 602 (which is, e.g., stored in the parent node of the node 602).

Above, it is stated that the BVH 501 determines which node references 604 to mark as “always hit” by calculating the surface area heuristic for different configurations and selecting the configuration with the lowest surface area heuristic. In some examples, the BVH 501 determines which configurations can be tested in the following manner. In one example, the configurations are simply every possible configuration (e.g., one configuration for each possible combination of being marked as “always hit” and not “always hit” for each node reference 604). However, because this results in a large number of combination (e.g., 2 raised to the power of the number of node references 604), in some examples, the BVH builder 501 determines which configurations to use in a different manner. In one example, the possible configurations are defined by a certain set of characteristics. In some such examples, one or more configurations are defined by marking one or more of the node references 604 having a true bounding volume that lies on at least one face of the overall bounding volume 706 as “always hit.” In such examples, the possible combinations include each possible combination of “always hit” and “not always hit” for each such node reference 604, but with node references 604 that do not lie on the overall bounding volume 706, such node references 604 cannot be marked as “always hit.”

In some examples, the BVH builder 501 determines which node reference(s) 604 to mark as “always hit” in the following manner. The BVH builder 501 begins with a node having all node references 604 not marked as “always hit.” The BVH builder 501 determines which such node references 604 are candidates for marking as “always hit.” The BVH builder 501 then calculates the surface area heuristic for each of a set of configurations. Each configuration is defined as having all node references 604 as “not always hit” and one of the candidates as “always hit.” Then, the BVH builder 501 selects the configuration with the lowest surface area heuristic, if that configuration has a lower surface area heuristic than the configuration with no node references 604 marked as always hit.

In some examples, the BVH builder 501 repeats this procedure beginning with the most recently determined configuration (a “baseline configuration”) to determine if another node reference 604 is to be marked as “always hit.” The BVH builder 501 calculates the surface area heuristic for all configurations with an additional node reference 604 marked as “always hit” and if the configuration with the lowest surface area heuristic has a lower surface area heuristic than that of the baseline configuration, the BVH builder 501 selects that new configuration as the new baseline configuration. If, at any point, the baseline configuration has a lower surface area heuristic, then the BVH builder 501 uses that configuration for the node 602 under consideration.

In some examples, the candidate node references 604 include any node reference 604 whose bounding volume defines at least a part of the overall volume 706 (e.g., lies on the edge of the overall volume 706).

In summary, in some examples, the BVH builder 501 determines which node references 604 are to be marked as “always hit” in an iterative fashion the following manner. In a first iteration, the BVH builder 501 starts with a baseline configuration with no node references 604 marked as “always hit” and identifies one or more such node references 604 as a candidate node reference 604. In an example, the candidate node references are node references 604 not already marked as “always hit” whose bounding volume lies on the overall bounding volume 706 (which is defined as bounding all nodes not marked as “always hit”). A set of candidate configurations is defined as the baseline configuration, along with one candidate configuration for each candidate node reference 604, wherein each such candidate configuration has that candidate node reference 604 set as “always hit” but otherwise has the same settings as the baseline configuration. The BVH builder 501 calculates the surface area heuristic for each such candidate configuration and identifies the candidate configuration with the lowest surface area heuristic, selecting that candidate configuration as the new baseline configuration. If the original baseline configuration was not selected, then the BVH builder 501 also updates the overall bounding volume 706 to bound all bounding volumes of node references 604 in the new baseline configuration that are not marked as “always hit.” In some examples, if the baseline configuration was not selected in the previous iteration, then the BVH builder 501 performs a new iteration, continuing to perform new iterations until the baseline configuration is selected or some other termination criterion is met (e.g., a maximum number of candidate nodes 604 have been marked as “always hit”).

FIG. 9 is a flow diagram of a method 900 for traversing a BVH with one or more node references 604 marked as “always hit,” according to an example. Although described with respect to the system of FIGS. 1-8, those of skill in the art will understand that any system configured to perform the steps of the method 900 in any technically feasible order falls within the scope of the present disclosure.

Prior to a method, an entity such as a shader program has generated a ray to traverse a BVH for ray tracing. The BVH includes at least one node reference 604 marked as “always hit.” At step 902, the ray tracing pipeline 300 traverses a BVH for the ray, to a node that includes at least one node reference 604 marked as always hit as well as another node reference 604 that is not marked as always hit. In various examples, the BVH has been built to include such node references 604. In addition, in some examples, the bounding volumes of the node references 604 in the traversed to node 602 are defined in a fixed-point format. Specifically, the node 602 includes an overall bounding volume that does not bound the bounding volume of the node reference 604 marked as always hit, but that does not the bounding volumes of the node references 604 in the node not marked as always hit.

At step 904, the ray tracing pipeline 300 traverses to children of the node reference 604 marked as always hit without testing the ray for intersection with the bounding volume of that node reference 604. More specifically, because that node reference 604 is marked as “always hit,” it is assumed that the ray hits that bounding volume and thus a test is not performed. Traversing to the children of that node 602 includes fetching the node references 604 of those children, testing the ray for intersection with the bounding volumes of those node references 604, and so on.

At step 906, the ray racing pipeline 300 tests the ray for intersection with the bounding volumes of the node references 604 not marked as always hit. More specifically, because these node references 604 are not marked as always hit, the ray tracing pipeline 300 does test the ray for intersection with the bounding volumes of such node references 604.

After these operations, in some examples, the ray tracing pipeline 300 further traverses the BVH as necessary. In various examples, the ray tracing pipeline 300 determines that the ray intersects one or more primitives, and uses this information to determine attributes such as color for one or more pixels of a render target (where “render target” means an output image or other image or set of information to which data is rendered).

As described above, the BVH builder 501 builds a BVH including one or more node references 604 marked as always hit. In some examples, once a BVH is built, the BVH builder 510 compresses one or more nodes 602 of the BVH using a fixed-point format. FIG. 10 is a flow diagram of a method 1000 for setting one or more node references 604 of a node to “always hit.” The method 1000 is performed for the node references 604 of one node. Although described with respect to the system of FIGS. 1-8, those of skill in the art will understand that any system configured to perform the steps of the method 1000 in any technically feasible order falls within the scope of the present disclosure.

At step 1002, the BVH builder 501 identifies two or more candidate configurations, where each candidate configuration identifies a different node reference 604 of the node as being marked as “always hit.” More specifically, each candidate configuration identifies, for each node reference 604 of the node 602, whether the node reference 604 is marked as “always hit.” In some examples, the candidate configurations include a baseline configuration, and one or more other configurations, where each other configuration differs from the baseline configuration in that one of the node references 604 not marked as “always hit” in the baseline configuration is marked as “always hit” in the other configuration. In some examples, for each candidate configuration other than the baseline configuration, one of the node references 604 that lies on at least one face of the overall bounding volume 706 of the baseline configuration is marked as “always hit.”

At step 1004, the BVH builder 501 identifies the candidate configuration having the lowest surface area heuristic, which is described elsewhere herein. At step 1006, the BVH builder 501 sets the node references based on the candidate configuration with the lowest surface area heuristic. In some examples, the BVH builder 501 continues with more iterations until a termination condition occurs, in order to identify a configuration, which indicates which node references 604 are to be marked as “always hit.” Then, the BVH builder 501 sets the node references 604 to “always hit” according to the identified configuration.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the compute units 132, the SIMD units 138, the ray tracing pipeline 300, including the ray generation shader 302, acceleration structure traversal stage 304, any hit shader 306, hit or miss unit 308, closest hit shader 310, miss shader 312, or the BVH builder 502, may be implemented as a general purpose computer, a processor, a processor core, or in digital circuitry or analog circuitry, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
for a ray, traversing a bounding volume hierarchy (“BVH”) to a node that includes a first node reference marked as always hit and a second node reference not marked as always hit;
traversing to one or more children of the first node without testing the ray for intersection with a bounding volume of the first node reference; and
testing the ray for intersection with a bounding volume of the second node reference.

2. The method of claim 1, wherein node references of the node are encoded in a fixed-point space.

3. The method of claim 2, wherein the fixed-point space includes a bounds that does not include any bounding volume for the node marked as always hit.

4. The method of claim 1, further comprising designating the first node reference as always hit in a BVH build operation.

5. The method of claim 4, wherein the BVH build operation includes evaluating a surface area heuristic for a plurality of candidate configurations.

6. The method of claim 5, wherein each candidate configuration includes a different node reference set as always hit.

7. The method of claim 1, further comprising terminating traversal of the bounding volume hierarchy upon reaching a termination point.

8. The method of claim 1, further comprising determining attributes for a pixel based on traversal of the bounding volume hierarchy for the ray.

9. The method of claim 1, wherein the testing comprises determining whether to traverse to a node pointed to by the second node reference based on whether the ray intersects the bounding volume of the second node reference.

10. A system comprising:
a memory storing at least a portion of a bounding volume hierarchy (“BVH”); and
a processor configured to:
for a ray, traverse the BVH to a node that includes a first node reference marked as always hit and a second node reference not marked as always hit;
traverse to one or more children of the first node without testing the ray for intersection with a bounding volume of the first node reference; and
test the ray for intersection with a bounding volume of the second node reference.

11. The system of claim 10, wherein node references of the node are encoded in a fixed-point space.

12. The system of claim 11, wherein the fixed-point space includes a bounds that does not include any bounding volume for the node marked as always hit.

13. The system of claim 10, wherein the processor is further configured to designate the first node reference as always hit in a BVH build operation.

14. The system of claim 13, wherein the BVH build operation includes evaluating a surface area heuristic for a plurality of candidate configurations.

15. The system of claim 14, wherein each candidate configuration includes a different node reference set as always hit.

16. The system of claim 10, wherein the processor is further configured to terminate traversal of the bounding volume hierarchy upon reaching a termination point.

17. The system of claim 10, wherein the processor is further configured to determine attributes for a pixel based on traversal of the bounding volume hierarchy for the ray.

18. The system of claim 10, wherein the testing comprises determining whether to traverse to a node pointed to by the second node reference based on whether the ray intersects the bounding volume of the second node reference.

19. A non-transitory computer-readable medium storing instructions that, when executed by a processor, cause the processor to perform operations comprising:
for a ray, traversing a bounding volume hierarchy (“BVH”) to a node that includes a first node reference marked as always hit and a second node reference not marked as always hit;
traversing to one or more children of the first node without testing the ray for intersection with a bounding volume of the first node reference; and
testing the ray for intersection with a bounding volume of the second node reference.

20. The non-transitory computer-readable medium of claim 19, wherein node references of the node are encoded in a fixed-point space.
